(19) United States
(12) Patent Application Publication
(10) Pub. No.: US 2019/0033869 A1
(43) Pub. Date: Jan. 31, 2019

(54) ROBOT WITH ROTATIONAL/TRANSLATION MOVEMENT

(71) Applicant: Neato Robotics, Inc., Newark, CA (US)

(72) Inventors: Matt HERRON, Hayward, CA (US); Ho Chong CHEUNG, Sunnyvale, CA (US)

(21) Appl. No.: 15/659,478

(22) Filed: Jul. 25, 2017

(51) Int. Cl. G05D 1/02; A47L 11/03; A47L 11/14; A47L 11/24; A47L 11/282; A47L 11/40

(52) U.S. Cl. CPC G05D 1/021; A47L 11/03; A47L 11/145; A47L 11/24; A47L 11/282; A47L 11/4011; A47L 2201/04; A47L 11/4052; A47L 11/4061; A47L 11/4005; A47L 11/4083; Y10S 901/01; G05D 2201/0203; A47L 11/4038

(57) ABSTRACT

In one embodiment, a robot is described which uses pads for both operating on a surface and movement of the robot. The pads are tilted about a single axis. In one embodiment, the pads are slightly curved. In one embodiment, three pads are used. By using an odd number of pads (e.g., 3) with one rotating in an opposite direction, translational movement can be achieved by using non-center contact points without varying the tilt angle and angular velocity of the pads to achieve a translation direction.

### BACKGROUND OF THE INVENTION

The present disclosure relates to the field of robotic devices, and in particular, a mobile cleaning/polishing/sanding/mopping/dusting robot capable of rotational and translational movement.

Robots traverse their environments in various ways. Most such robots use powered wheels of some kind. The wheels themselves perform no cleaning or other treatment function.

There also are cleaning robots with pads, sponges, or the like, with motors to move and/or rotate the pads and/or sponges. For the most part, the pads/sponges perform no motive function. Samsung EP2875768 shows a robot cleaner with four round cleaning pads. Instead of using wheels, the cleaning pads are separately tilted during rotation to move the robot, with multiple tilt axes. A similar cleaning robot is shown in Samsung US Pub. No. 2015/0142169, showing embodiments with either two or four pads. Tilting the pads is used to move the cleaning robot, along with changing the rotation direction. The rotation speed is varied for different cleaning modes. Both references show each pad tilting in both the x and y directions, with separate tilting mechanisms.

### BRIEF SUMMARY OF THE INVENTION

In one embodiment, a robot is described which uses pads for both operating on a surface (e.g., cleaning sanding, etc.) and movement of the robot. In one embodiment, 3 pads are used instead of the 4 pads of the prior art. With 3 pads, each pad will be touching the surface, including on an uneven surface. In addition, the shape of a 3 pad robot allows the robot to make tight turns and maneuver in certain small spaces better than a 4 pad robot. The pads can be cleaning pads, polishing pads, sanding pads, mopping pads, dusting pads or other types of pads. Translational movement of the robot can be controlled by varying the tilt angle of the pads, the rotational velocity, and the rotational direction.

In one embodiment, a first mode of translation keeps the rotation speeds of the pads constant, while varying the tilt angles. The varying tilt axes move the contact point of the pads away from their centers, providing a varying force vector to move the robot in a desired direction. The tilt angle variations can cause the robot to move both translationally, and rotating (spinning) at the same time. The rotation direction of the pads may also be varied.

In one embodiment, a second mode of translation keeps a fixed tilt axis of each of the pads, while varying the rotation speeds of the pads, The rotation direction of the pads may also be varied. The fixed tilt axes move the contact point of the pads away from their centers, providing a force vector to move the robot in a desired direction. By selecting an appropriate fixed tilt angle for each of the pads to a desired force vector position, rotational velocity can then be used to move the robot translationally, and also rotate the robot for the cleaning or other operation.

In yet another embodiment, a third mode of translation varies both the rotation speeds and the tilt angles. The angles and rotation speeds can be optimized to provide the most effective operation or treatment on the surface during translation. The rotation direction of the pads may also be varied in all 3 modes.

In yet another embodiment, the robot is controlled to slowly spin as it translates, to improve the uniformity of its operation on the surface (cleaning, sanding, etc.). Alternately, the robot spinning is controlled to rotate it to a desired orientation to get into tight corners, around objects, etc.

In one embodiment, the pads are tilted about a single axis, reducing the size, complexity and power requirements compared to a prior art multi-axis configuration. With a 3 pad embodiment, the single axis can provide tilting toward and away from the center of the robot, such that the tilt angle creates a force vector that has both x and y components, thus providing the ability to move in any direction.

In one embodiment, the pads have a slightly convex curved surface. This provides a more uniform contact surface, and the ability to continue cleaning, when the pads are tilted for translation and rotational movements. The pads can be of a soft material that compresses, providing a larger footprint on the floor, even though there is a slight curve. The pad can be designed to be slightly uneven, with a compressible material, such that all portions may touch the floor and clean, but some parts, off-center, are more compressed with higher friction, thus effectively moving the centroid of the point of contact off-center.

In one embodiment, at least one pad may be slipping during translational movement in a 3 pad configuration. Accordingly, a gyroscope, accelerometer, or other rotational sensor is mounted on the robot to provide signals showing the actual orientation of the robot during translation. This allows a processor to compensate for the slippage, such as by adjusting the rotational speed of one or more of the pads accordingly. While the sensor shows whether the robot is spinning as desired, the information can also be used as feedback on whether it is translating as desired, which may be inferred from the amount of spinning slippage. Alternately, or in addition, the location of the robot can be monitored, such as through a SLAM method, to detect any translational slipping.

In one embodiment, the pads are mounted on an omni wheel. The pads will contact the floor when flat and at small angles. The pads can be tilted outwards at a steep angle, or vertically, to ride on the omni wheel. This allows faster movement and higher ground clearance while riding on the omni wheel. In addition, it allows traversing a carpeted or other surface that is not appropriate for cleaning with the pads, such as moving across a carpet from one hard surface floor to another. The use of an omni wheel allows translation movement in any direction, not just the direction provided by the edge of the pad. Because the edge is an omni wheel that can move in any direction, and because the contact point will be offset from the center, a force vector is provided that can be used for movement direction, similar to the pad force vectors.

### BRIEF DESCRIPTION OF THE DRAWINGS

FIG. 1A illustrates one aspect of a robot according to an embodiment of the present disclosure.

FIG. 1B illustrates another aspect of a robot according to an embodiment of the present disclosure.

FIG. 1C illustrates another aspect of a robot according to an embodiment of the present disclosure.

FIG. 2 illustrates a top view of a robot according to an embodiment of the present disclosure.

FIG. 3A illustrates a bottom view of a robot according to an embodiment of the present disclosure.

FIG. 3B illustrates another bottom view of a robot according to an embodiment of the present disclosure.

FIG. 3C illustrates another bottom view of a robot according to an embodiment of the present disclosure.

FIG. 4 illustrates a pad of a robot according to another embodiment of the present disclosure.

FIG. 5 illustrates a flow diagram of a method according to another embodiment of the present disclosure.

FIG. 6 is a diagram of a the electronic system for a robot according to an embodiment.

FIG. 7 is a simplified block diagram of a representative computing system and client computing system usable to implement certain embodiments of the present invention.

FIG. 8 is a diagram of a robot with a LIDAR turret according to an embodiment.

FIG. 9 is a diagram of a robot and charging station according to an embodiment.

FIG. 10 is a diagram of a smartphone control application display for a robot according to an embodiment.

FIG. 11 is a diagram of a smart watch control application display for a robot according to an embodiment.

FIG. 12 illustrates a perspective view of the robot of FIG. 2 according to an embodiment of the present disclosure.

FIG. 13 illustrates a perspective view of one servo motor and pad combination of the robot of FIG. 12 according to an embodiment of the present disclosure.

FIG. 14 is a diagram of a pad with an omni wheel according to an embodiment.

FIG. 15 is a diagram of a pad with omni wheels in the non-tilted position, where the pads are operational.

### DETAILED DESCRIPTION OF THE INVENTION

Embodiments of the present disclosure provide a robot capable of engaging in translational and rotational motion by generating force vectors and/or torque at one or more of a plurality of pads. Embodiments also include methods of providing such translational and rotational motion.

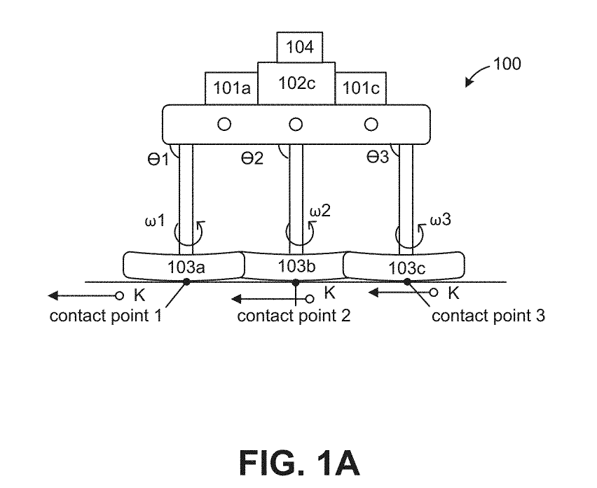

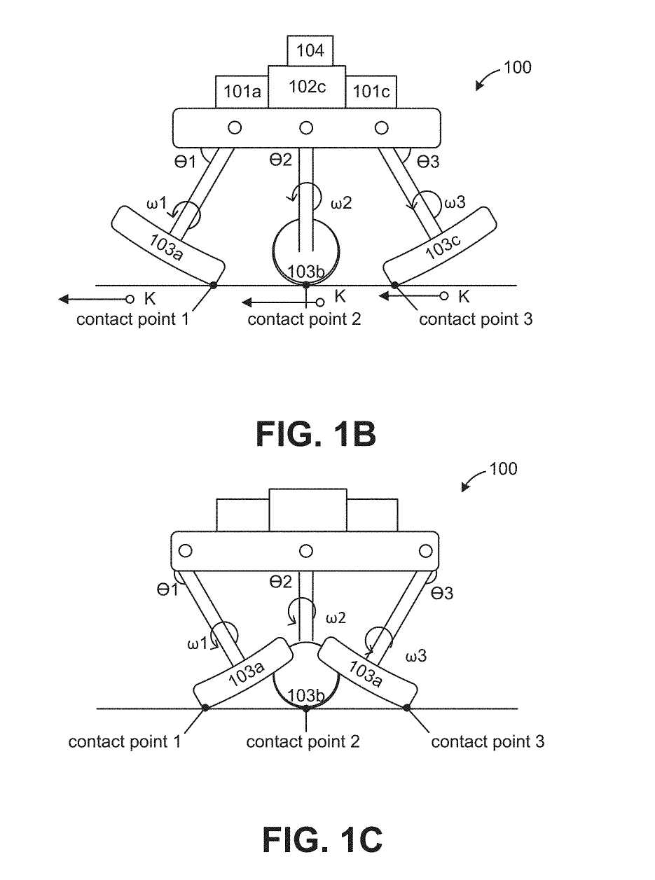

FIG. 1A illustrates a side view of an apparatus 100 in accordance with an embodiment of the present disclosure. In the context of the present disclosure, apparatus 100 is a robot.

Apparatus 100 may include motors 101a-c, servos 102a-c, pads 103a-c and microprocessor 104 (servos 102a and 102b, as well as motor 101b are not shown in this view). Each of motors 101a-c and servos 102a-c may be operatively coupled to a respective pad 103a-c. By way of non-limiting example, pads 103a-c may be cleaning pads, polishing pads, sanding pads, dry mopping pads, wet mopping pads, or dusting pads. In an embodiment, pads 103a-c may be sponges or other apparatus that can absorb and/or distribute water or other fluid, for example liquid wax, liquid detergent, a soap solution, abrasive slurry, or the like. Generally, pads 103a-c may be any kind of pad which interacts with a floor or other surface to perform some kind of cleaning, polishing, dusting, mopping, sanding, or other such type of task on the surface. The surface can be generally flat, inclined, or any shape accessible by the robot. In an embodiment, robot 100 may include a reservoir or other source (not shown) for dispensing water or other fluid, and/or for containing water or other fluid that is picked up from the floor. The pads may be removable and disposable. The pads can be attached and removed using a variety of mechanisms, such as Velcro®, straps, microdots, screws, magnets, etc.

As shown in FIG. 1A, each motor 101a-c may rotate a respective pad 103a-c at an angular velocity (shown respectively as ω₁, ω₂ and ω₃). Each servo 102a-c may orient a respective pad 103a-c at an angle θ relative to the ground plane (shown respectively as θ₁, θ₂ and θ₃). Ordinarily skilled artisans will recognize that, with three pads (which in one embodiment are arranged in an equilateral triangle, with one at each vertex), each of the angles θ₁, θ₂ and θ₃, while the same, are shown at the same orientation for ease of illustration. In FIG. 1A, θ₂ for example may be at a different orientation than θ₁ and θ₃.

### First Mode: Fixed Angular Velocity, Variable Tilt Angle.

In one mode of operation, each motor 101a-c may rotate its respective pad 103a-c at a fixed angular velocity. In an embodiment, motors 101a-c may rotate their respective pads 103a-c at the same fixed angular velocity (i.e. ω₁=ω₂=ω₃). For each pad, the angle θ may relate to the point or area of contact (shown as contact point 1, 2 and 3, but also referring to an area) between the pad and the ground as further described herein. Therefore, as a servo changes the angle θ of a particular pad, the contact point between that pad and the ground will shift, from an area on point at the outer circumference of each pad, to the opposite area or point at an outer circumference of each pad across the center of rotation.

The interaction between a pad and the ground at the point of contact will create frictional forces (K), which are represented in FIG. 1A as K. For each pad, K may be represented as a function of the coefficient of friction of the pad, the coefficient of friction of the ground, the angle θ of the particular pad, the angular velocity of the particular pad and the normal downward force exerted between each pad and the ground.

FIG. 1B illustrates the apparatus 100 with an angle θ for each pad tilting the pads away from the center of the apparatus FIG. 1C illustrates the apparatus 100 with an angle θ for each pad tilting the pads toward the center of the apparatus. As will be discussed in more detail below, the different tilt on the pads will result in different force vectors.

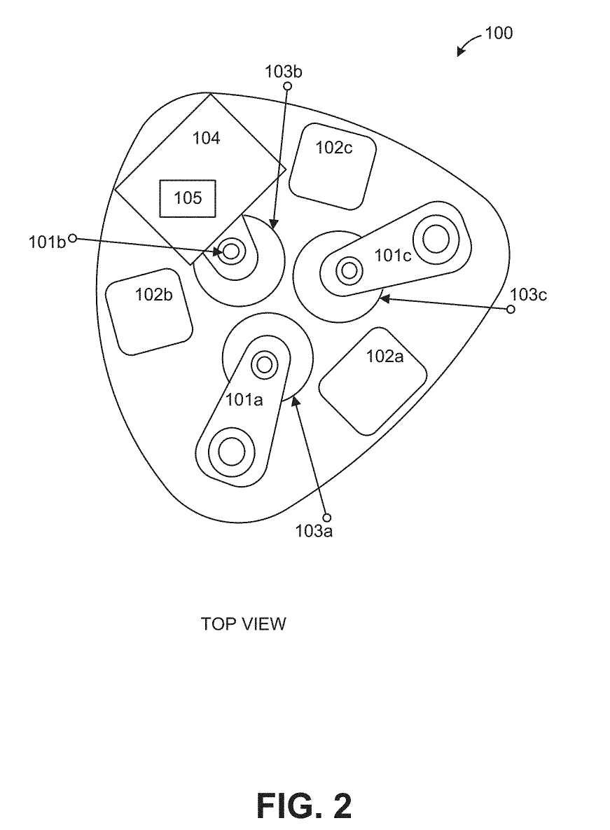

FIG. 2 illustrates a top view of the apparatus 100 according to an embodiment of the present disclosure, with an example configuration of motors 101a-c, servos 102a-c, pads 103a-c, microprocessor 104, and gyroscope 105 within the apparatus 100. In an embodiment, elements 104 and 105 may be on the same integrated circuit die. In other embodiments, elements 104 and 105 may be physically separate devices. Gyroscope 105 may be a micro-electromechanical system, or MEMS device, system, or subsystem and may be on the same integrated circuit die with its own onboard microprocessor (not shown). Other sensors than a gyroscope could be used, such as accelerometers. Alternately, torque can be monitored through a strain gauge or otherwise, or current to the rotational motors can be measured, to infer an amount of frictional force. In various embodiments, gyroscope 105 may provide angular velocity and/or orientation information to microprocessor 104, which may then calculate the necessary force vectors to maintain the stability of apparatus 100's rotational movement which has been instructed as described herein In one or more embodiments, microprocessor 104 may be a microcontroller.

The discussion herein involves multiple modes of operation of the apparatus 100. A first mode of operation may generate rotational and translational movement by varying the angle θ of one or more pads as described herein, while keeping w fixed for each pad.

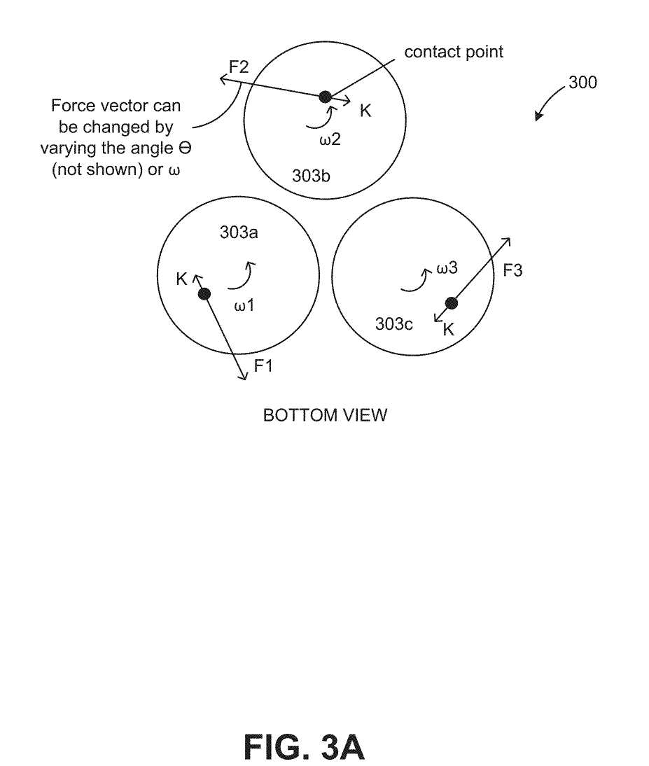

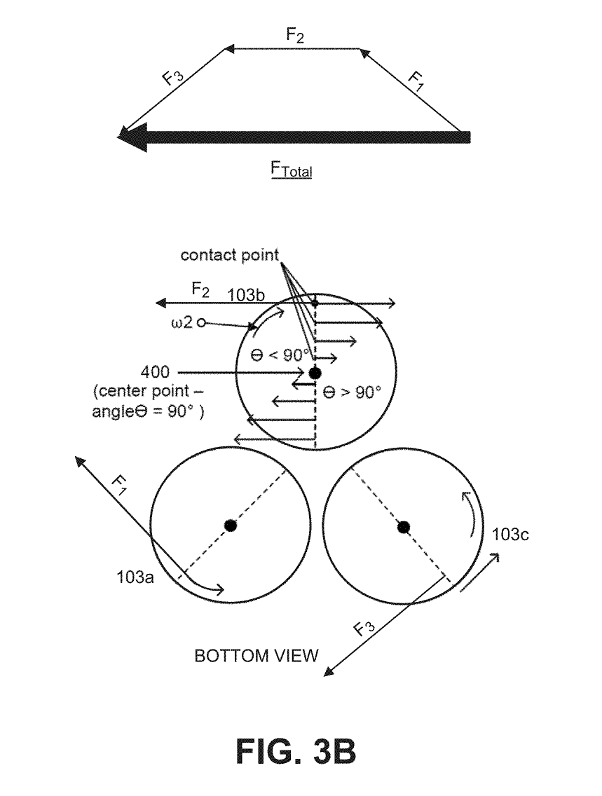

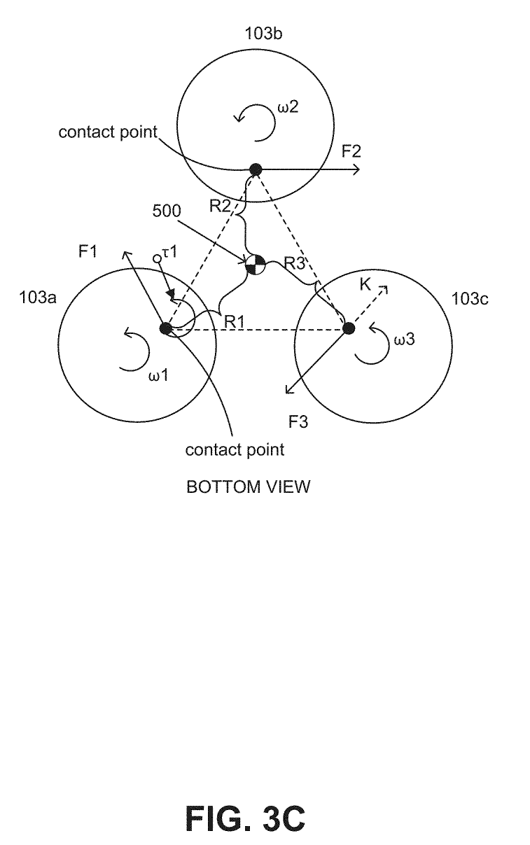

FIG. 3A illustrates an exemplary bottom view of pads 303a-303c in a robot 300 according to an embodiment of the present disclosure. For each pad, the respective ω, θ and K values may define a force vector at the point or area of contact between the pad and the ground. The force vector for each pad may be represented as a function of K, ω and θ. Thus, for example, the force (F₁) generated at pad 303a may be represented as a function of K, ω₁ and θ₁ (not shown). In an embodiment, the force vector for each pad may be approximated as F=K×ω. The apparatus 300 may achieve translational motion by generating force vectors at one or more pads 303a-c, the sum of which may create a total system force vector (Fₜₒₜₐₗ) (not shown) having magnitude and direction that correspond to the desired direction of translational motion. Fₜₒₜₐₗ may be represented as a function of θ₁₋₃ (not shown), ω₁₋₃ and K. In a first mode of operation, apparatus 300 may change the direction of travel, speed of travel or both by adjusting the angle of orientation (θ) of one or more of the pads as discussed in more detail herein.

Returning to FIG. 1A, the microprocessor 104 may include a virtual map (not shown) of an area to be cleaned. The creation of the virtual map may occur according to a number of techniques. In an embodiment, apparatus 100 may download the map from a central location, or may receive it from another robot which can traverse the same area. In another embodiment, the apparatus may create the map itself, using a laser distance sensor (LDS) apparatus, such as Light Detection and Ranging (LIDAR). Alternately, VSLAM (Visual SLAM using image sensors) or other localization methods can be used. The LDS, image sensor or other apparatus may be operatively coupled to a motor in apparatus 100 such that the localization apparatus may rotate at a different angular velocity than that of apparatus 100. For example, while apparatus 100 rotates at ωₐ, the localization apparatus may rotate at ω_{b}, where ωₐ is different from ω_{b}. As the localization apparatus rotates, it may scan the environment of apparatus 100 to create a virtual map. Microprocessor 104 may use the virtual map to detect indications in the operational area that may require a change in direction or speed. For example, microprocessor 104 may use the virtual map to have the apparatus 100 proceed through an operational area to perform an operation or treatment, such as cleaning. In an embodiment, microprocessor 104 may instruct movement of the apparatus 100 using a preprogrammed routine. In an embodiment, microprocessor 104 may use the virtual map, alone or in conjunction with a laser distance sensor system or other localization system, to determine when the apparatus 100 is approaching a wall, or other obstruction.

In an embodiment, microprocessor 104 may receive signals from a remote device such as a remote control, embodied as a joystick or any other apparatus enabling similar functionality that may provide indications that rotational and/or translational movement, or a change in movement, direction and/or speed is necessary. In response to detecting or receiving such indications, microprocessor 104 may determine the force vector needed at one or more of pads 103a-c to achieve an Fₜₒₜₐₗ corresponding to translational movement in the desired direction. In a first mode of operation, microprocessor 104 may calculate the angle θ needed to shift the contact point of each of the pads 103a-c such that the needed force vector at each of those pads is produced. Microprocessor 104 may then instruct the respective servos 102a-c of those pads to shift the angle θ of their pads to the angle θ needed to achieve the force vectors necessary at each pad for the desired Fₜₒₜₐₗ.

FIG. 3B is a diagram of the magnitude and direction of a force vector generated at various contact points along a pad for a fixed angular velocity (ω). A contact point at the center of the pad 400 may correspond to an angle θ of 90 degrees, which may generate a force vector having magnitude of 0. As can be seen, the magnitude of the force vector generated will increase as the angle θ deviates from 90 degrees. Depending on the direction and the amount of deviation, the magnitude of the force vector generated will increase, but have a direction component in opposite directions. Force vectors F1, F2 and F3 are shown, and can be made to add to a force vector Ftotal in the desired translation direction, rotation, and with an amplitude corresponding to the desired speed. A torsional strain gauge or motor current sensor is used in one embodiment to measure the force produced by the rotating pad, and feed that information back to the microprocessor to use for stability and control.

### Rotational or Spinning Movement

In an embodiment, the apparatus 100 may rotate or spin, and in a further embodiment, may rotate or spin while it is undergoing translational movement. Rotational movement may serve a variety of purposes. For example, rotational movement may provide a more thorough or consistent cleaning or other treatment function. In an embodiment, the apparatus 100 may determine that certain areas in an operational area require additional or more thorough treatment, and may instruct the apparatus to rotate in that area, causing the pads to perform additional treatment while the apparatus is in that area. The apparatus 100 may make this determination according to conventional techniques. For example, the apparatus 100 may utilize a sensor, such as a piezoelectric sensor, optical sensor or other sensor to monitor non-topological features such as surface dirt concentration, among other features. Upon detecting a relatively high concentration of surface dirt in a particular area, the apparatus 100 may instruct rotational movement in addition to translational movement to help clean that particular area. A “high” concentration of surface dirt may be defined as a concentration that exceeds a threshold surface dirt concentration criteria. Rotational movement of the apparatus 100 may correspond to the total system torque (τₜₒₜₐₗ) of the apparatus 100. The apparatus 100 may rotate by generating torque at one or more pads. The sum of the generated torques may yield a total system torque (τₜₒₜₐₗ) corresponding to the desired rotational speed. The apparatus 100 may control the τₜₒₜₐₗ by varying the angle θ and/or the ω of one or more pads.

FIG. 3C illustrates a bottom view of movement of the pads relative to a central axis of rotation 500. R may signify a position vector from the axis of rotation 500 (in this case, the center of apparatus 100) to the point of contact between a pad and the ground. Thus, for example, R₁ may correspond to the position vector from the axis of rotation 500 to the point or area of contact between pad 103a and the ground. When the point or area of contact between a pad and the ground is at the center of the pad, this may correspond to an angle θ=90°. When the angle θ varies from 90°, the point or area of contact will move from the center of the pad.

τₜₒₜₐₗ may be represented as a function of θ₁₋₃, ω₁₋₃ and K. The torque generated at each pad may be given as τ=R×F (where x represents the cross product function). Thus, the torque generated at pad 103a may be given as τ₁=R₁×F₁. In a first mode of operation, as the angle θ of a pad changes, the contact point between that pad and the ground may change as well (as discussed herein). Therefore, changes in the angle θ of a pad may relate to changes in the position vector R between that pad and the axis of rotation 500 as well as changes in the force vector generated at that pad. Microprocessor 104 may determine the level of τₜₒₜₐₗ needed to achieve the desired amount of rotational movement and the torque needed at one or more pads 103a-c to achieve the desired τₜₒₜₐₗ. In an embodiment, microprocessor 104 may then determine the angle θ needed at those pads to generate both the desired Fₜₒₜₐₗ and τₜₒₜₐₗ. Microprocessor 104 may then instruct the respective servos 102a-c of those pads to adjust the angle θ of those pads accordingly.

Microprocessor 104 may determine the torque needed at one or more pads 103a-c to achieve the desired τₜₒₜₐₗ In an embodiment, microprocessor 104 may determine the angle θ needed at those pads to generate the torque needed at those pads. Microprocessor 104 may then instruct the respective servos 102a-c of those pads to adjust the angle θ of those pads accordingly. Thus, in various embodiments, the apparatus 100 may generate only torque such that it engages only in rotational movement.

In an embodiment, the robot apparatus 100 may spin in place for a more intensive cleaning or other operation. The robot may also be rotated to a particular orientation to best fit into a corner, navigate an obstacle, etc. Once in the desired orientation, the robot can be translated as desired. The orientation may change with translation, such as to have the same edge of the robot face an obstacle as the robot translates along the varying edge of the obstacle.

### Second Mode: Fixed Tilt Angle, Variable Angular Velocity.

In a second mode of operation, the pads may have a fixed tilt angle, with the rotational velocity varied to provide translational movement. The second mode of operation may generate rotational and translational movement by varying ω for one or more pads, while keeping θ fixed for each pad. The force vector calculations would be as described above, but with rotational velocity varying instead of tilt angle (with tilt angle determining the contact point). Each servo 102a-c may orient its respective pad at a fixed angle θ. Therefore, the contact point or area between each pad and the ground plane does not vary. In an embodiment, servos 102a-c may fix their respective pads at the same fixed angle θ (i.e. θ₁=θ₂=θ₃). The second mode of operation may vary the angular velocity of each pad independently.

In the second mode of operation, apparatus 300 may change the direction of travel, speed of travel or both by adjusting the angular velocity (ω) of one or more pads, also as discussed in more detail herein. The pads may be operated at different angular velocities and different rotational directions to achieve the desired translational direction and speed.

Returning once again to FIG. 1A, in the second mode of operation, upon determining the force vector necessary at one or more pads 103a-c to achieve an Fₜₒₜₐₗ corresponding to translational movement in a desired direction, microprocessor 104 may calculate the ω needed at those pads 103a-c such that the needed force vector at each of those pads is produced. Microprocessor 104 may then instruct the respective motors 101a-c of those pads to change the ω of their pads to the ω needed so as to achieve the force vectors necessary at each pad for the desired Fₜₒₜₐₗ.

In the second mode of operation, because the angle θ of each pad may be fixed, it follows that R₁, R₂ and R₃ may not change (since both contact points and axes of rotation are now fixed). However, as discussed herein, changes in the ω of a pad may relate to changes in the force (and thus, the torque) generated at that pad. Microprocessor 104 may determine the level of τₜₒₜₐₗ needed to achieve the desired amount of rotational movement and the torque needed at one or more pads 103a-c to achieve the desired τₜₒₜₐₗ. In an embodiment, microprocessor 104 may determine the co needed at those pads to generate both the desired Fₜₒₜₐₗ and τₜₒₜₐₗ. Microprocessor 104 may then instruct the respective motors 101a-c of those pads to adjust the ω of those pads accordingly. Thus, in various embodiments, the apparatus 100 may control Fₜₒₜₐₗ and τₜₒₜₐₗ simultaneously by varying the angle θ or the ω of one or more pads.

### Third Mode: Variable Angular Velocity, Variable Tilt Angle.

In a third mode of operation, both tilt and angular velocity can be varied. They can be both be varied for each pad, or each pad can have one of tilt angle or rotational velocity varied.

### Cleaning the Pads.

In another embodiment, apparatus 100 may determine that one or more of pads 103a-c needs to be cleaned. Apparatus 100 may make this determination according to conventional techniques. For example, apparatus 100 may utilize a sensor, such as an optical sensor, to monitor surface dirt concentration on one or more of pads 103a-c. Alternately, a timer may be used to determine when a pad needs to be cleaned. Upon detecting a relatively high concentration of surface dirt on one or more of pads 103a-c, or upon reaching a threshold time, apparatus 100 may instruct movement to an area where one or more of pads 103a-c can be cleaned. For example, apparatus 100 may instruct movement to a reservoir or other source of fluid. By way of non-limiting example, the fluid may be solvent, detergent, water, soap, soap solution, or any other type of fluid that would aid the function of the robot. Upon entering the reservoir or other source of fluid, apparatus 100 may instruct at least one of pads 103a-c to rotate such that dirt accumulated in the pad(s) is released. Subsequently, apparatus 100 may instruct movement such that apparatus 100 exits the reservoir or other source of fluid. In one embodiment, the apparatus 100 exits into a drying area with barriers to prevent cleaning or other liquids from being spread on flooring. Apparatus 100 may then instruct pads 103a-c to rotate in order to release any fluid absorbed from the reservoir or other source of fluid, thereby drying pads 103a-c. This can be a drying spin cycle, with spun off water captured in the drying area. In one embodiment, pads 103a-c may release such fluid by translating or rotating over a ribbed surface. Further, as apparatus 100 navigates to or exits the reservoir or other source of fluid, as described above, apparatus 100 may traverse inclining or declining surfaces. Alternately, the apparatus can instruct the user to manually clean or replace the pads. The instruction can be through a user interface on the apparatus, and/or a communication to a user device.

### Gyroscope or Other Rotational Feedback Sensor.

Returning to FIG. 2, in an embodiment, the apparatus 100 may include a gyroscope 105 or other rotational sensor, which may be implemented or configured as discussed previously. Gyroscope 105 may enable the apparatus 100 to maintain the stability of its rotational motion by providing information corresponding to orientation and/or angular velocity to apparatus 100. For example, information about sudden changes in orientation, or changes in angular velocity of one or more pads, may signify changes in traction at those pads (slipping), or changes in the surface over which those pads are operating. Such changes could result in an unwanted change in direction and/or rotation of the apparatus 100.

Upon determining the force vectors necessary at one or more pads 103a-c to achieve an Fₜₒₜₐₗ corresponding to a desired direction of travel, microprocessor 104 may use gyroscope 105 to monitor changes in rotational orientation of apparatus 100 to ensure that the force vectors generated correspond to the instructed movement. In an embodiment, microprocessor 104 calculates the necessary force vectors to enable the appropriate rotational and/or translational movement. Gyroscope 105 can provide feedback to microprocessor 104, so that microprocessor 104 can calculate and then issue any necessary corrections to the motors and/or the servos.

By way of example only, to achieve motion in a particular direction, microprocessor 104 may determine the specific force vectors needed at pad 103a, pad 103b and pad 103c respectively to maintain a desired heading and velocity. The surface over which apparatus 100 operates may exhibit different frictional components in different areas, or the pads in apparatus 100 may have different coefficients of friction depending, for example, on how much liquid or cleaning fluid one pad has, or encounters, as compared with another. Additionally, there may be a change in surface contour over which one or more pads are operating, thus resulting in an unwanted change in the contact point between the pads and the surface and/or speed of those pads. Subsequently, the unwanted change in angle of orientation or speed at one or more particular pads may result in an unwanted change in the force vector generated at that pad. This unpredictable variance in the friction and/or point of contact may change the force vectors in such a way that the apparatus 100 may rotate away from the intended heading. Microprocessor 104 may then use gyroscope 105 to monitor changes in the rotational heading of apparatus 100 and individually adjust the force vectors generated at each pad to rotate apparatus 100 back to the correct heading.

In a first mode of operation, microprocessor 104 may calculate the angle θ needed at those pads to restore the force vectors and instruct one or more of the respective servos of those pads to alter the corresponding angle θ accordingly. In a second mode of operation, microprocessor 104 may calculate the ω needed at those pads restore the force vectors and instruct one or more of the respective motors of those pads to alter the corresponding ω accordingly.

In an embodiment, the apparatus 100 may include fluid dispensing units (not shown) to dispense cleaning fluid to provide more thorough cleaning. By way of non-limiting example, the fluid may be floor wax, floor polish, solvent, detergent, water, soap, soap solution, or any other type of cleaning fluid. The apparatus 100 may dispense the cleaning fluid as desired. In an embodiment, the dispensing may be periodic, while the robot is traversing a particular path. In an embodiment, the dispensing may occur upon a change in direction, speed, or other operation of the apparatus. In an embodiment, the dispensing may begin or end upon detection of particular type of floor covering. The ordinarily skilled artisan will appreciate that other criteria may affect cleaning fluid dispensing.

### Omni Wheel.

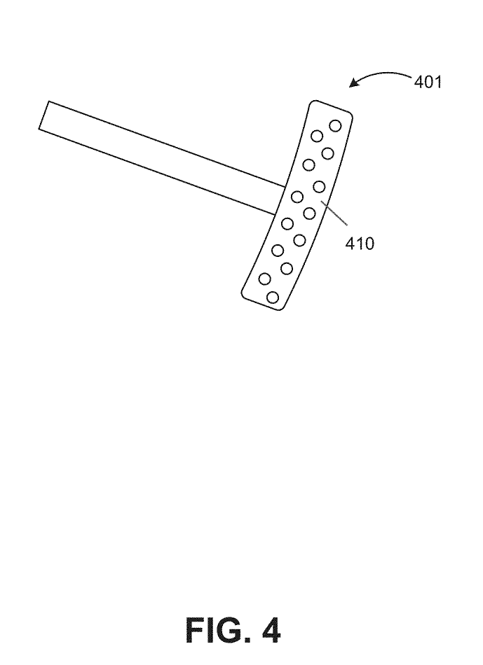

FIG. 4 shows a pad 401 in accordance with an embodiment of the present disclosure. Pad 401 may have an edge or boundary extending around the pad. The edge or boundary may include a lining, ring, omni wheel, Ezekiel wheel, or other surface 410. The surface 410 may be made of any material capable of generating friction with the ground (non-limiting examples would be rubber or plastic of various types, with or without a tread). FIG. 4 shows surface 410 with a number of bumps or protrusions. These may be made of a material different from that of the rest of the pad, so as to provide greater traction, as now will be discussed.

Robot 100 may encounter an area or surface that the robot cannot traverse in a normal mode of operation. In response to detecting such a condition, the microprocessor 104 may instruct a respective servo 102 (not shown) of pad 401 to articulate pad 401 to an angle θ sufficient to enable the surface 410 to contact the ground, so that the pad acts similarly to a wheel. Microprocessor 104 also may instruct a respective motor 103 (not shown) of pad 401 to rotate the pad, thereby creating frictional engagement between the surface 410 and the ground, and enabling the robot to move. This configuration may enable robot 100 to traverse different types of terrain or floor treatments. This arrangement may come in handy, for example, where robot 100 is moving from one area to another to perform cleaning, but must pass through an area with a different surface. Once the robot reaches the next area to be cleaned, the pad 401 may be returned to its previous orientation, with the surface 410 now out of contact with the ground.

Depending on the surface or terrain to be traversed, it may be that only two of the pads needs to be placed at an angle sufficient for its respective surface 410 to contact the ground.

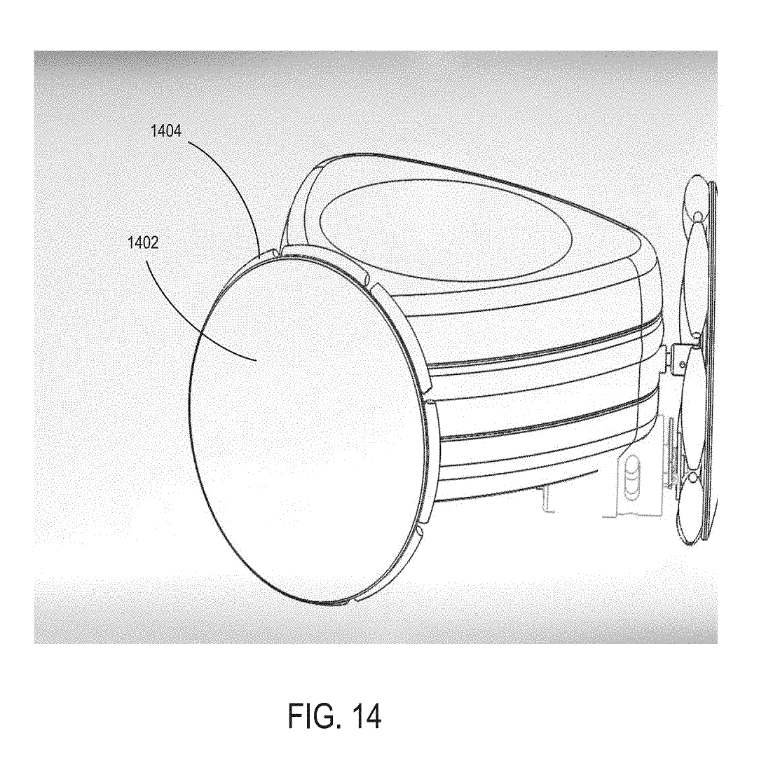

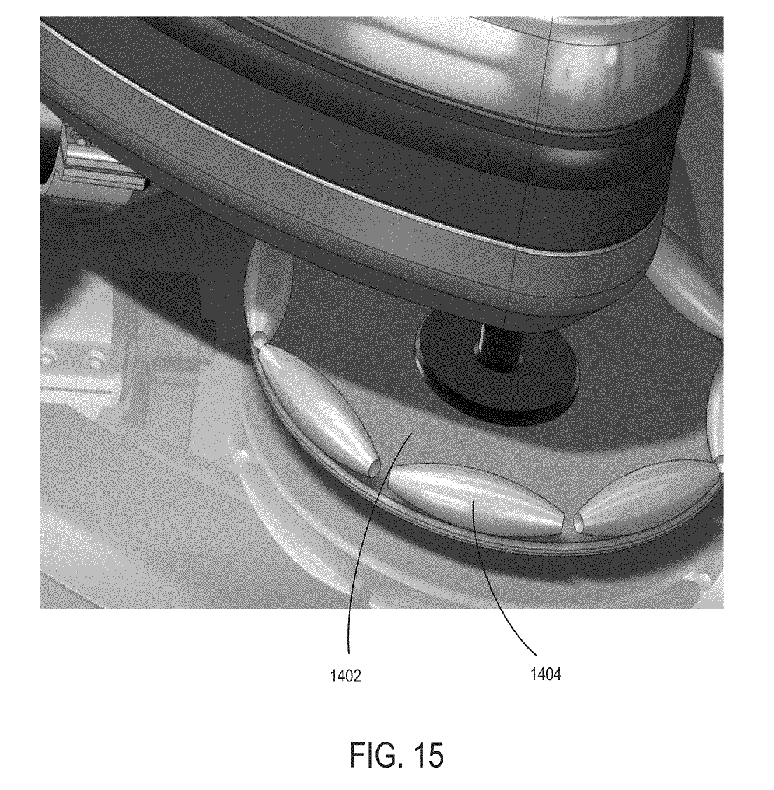

FIG. 14 is a diagram of a pad 1402 with an omni wheel 1404 according to an embodiment. In one embodiment, the pads are mounted on an omni wheel. The pads will contact the floor when flat and at small angles. The pads can be tilted outwards at a steep angle, or vertically, as shown in FIG. 14, to ride on the omni wheel. FIG. 15 is a diagram of a pad with omni wheels in the non-tilted position, where the pads are operational. This allows faster movement and higher ground clearance while riding on the omni wheel. In addition, it allows traversing a carpeted or other surface that is not appropriate for cleaning with the pads, such as moving across a carpet from one hard surface floor to another. The use of an omni wheel allows translation movement in any direction, not just the direction provided by the edge of the pad. Because the edge is an omni wheel that can move in any direction, and because the contact point will be offset from the center, a force vector is provided that can be used for movement direction, similar to the pad force vectors. In one embodiment, only two of the pads are tilted to activate the omni wheel, while the remaining pad can continue with a cleaning or other operation.

### Flow Diagram

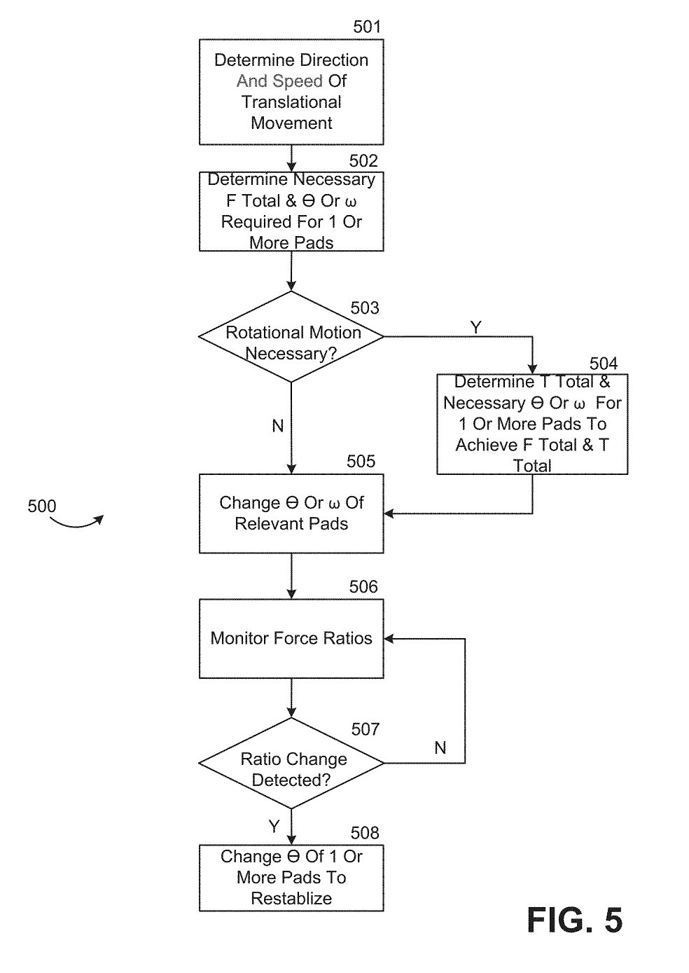

FIG. 5 illustrates a flow diagram of a method 500 for generating translational and rotational movement in a robot according to an embodiment of the present disclosure. The robot may include a plurality of motors, servos, pads and a microprocessor, as well as a gyroscope, according to embodiments discussed previously.

First Mode, Fixed Angular Velocity.

Method 500 may rotate one or more pads at an angular velocity (ω), and may orient one or more of the pads at an angle θ relative to the ground plane. In a first mode of operation, each pad may rotate at a fixed angular velocity. In an embodiment, method 100 may rotate all pads at the same fixed angular velocity (i.e. ω₁=ω₂=ω₃). For each pad, the angle θ may relate to the point of contact between the pad and the ground. Therefore, as the angle θ changes for a particular pad, the contact point or area between that pad and the ground may change.

Second Mode, Fixed Angles.

In a second mode of operation, each pad may be oriented at a fixed angle θ. In an embodiment, all pads may be oriented at the same fixed angle (i.e. θ₁=θ₂=θ₃).

The interaction between a pad and the ground at the point or area of contact may create frictional forces (K). For each pad, K may be represented as a function of the coefficient of friction of the pad, the coefficient of friction of the ground, the θ of the particular pad and the angular velocity of the particular pad.

At 501, method 500 may determine the desired direction and speed of movement of a robot. These determinations may be made, and the associated control carried out, as discussed previously with respect to the embodiment of FIG. 1.

At 502, in response to determining the desired direction of movement, method 500 may calculate the total system force (Fₜₒₜₐₗ) required to achieve translational movement in the desired direction, at the desired speed.

First Mode, Fixed Angular Velocity.

For each pad, the respective ω, θ and K values may define a force vector at the point or area of contact between the pad and the ground. Method 500 may achieve translational motion by generating force vectors at one or more pads. The sum of the force vectors will create an Fₜₒₜₐₗ having magnitude and direction that correspond to the desired direction and speed of travel. In a first mode of operation, method 500 may calculate the force vector needed at one or more pads to achieve the desired Fₜₒₜₐₗ and subsequently, calculate the needed angle θ for each of those pads, for a given ω, to generate the needed force vectors. Method 500 may then orient each of those pads to its respective calculated angle θ.

Second Mode, Fixed Angles.

In a second mode of operation, method 500 may calculate the force vector needed at one or more pads to achieve the desired Fₜₒₜₐₗ and subsequently, calculate the needed ω for each of those pads, for a given θ, to generate the needed force vectors. Method 500 may then adjust the ω of each of those pads to its respective calculated ω.

At 503, method 500 may determine whether rotational movement is to be integrated into the translational movement of the cleaning apparatus. In an embodiment, method 500 may integrate a rotational movement into the translational movement of the cleaning apparatus to provide a more thorough or consistent cleaning or other treatment function as described above.

At 504, upon determining that rotational movement is necessary, method 500 may generate rotational motion by controlling the total system torque (τₜₒₜₐₗ). Method 500 may achieve rotational motion by generating torque at one or more pads. The sum of the torques may create a τₜₒₜₐₗ corresponding to the desired level of rotational motion. Method 500 may accomplish this by varying the angle θ or the ω of one or more pads. The torque generated at each pad may be given as τ=R×F (where x represents the cross product operator). F may be the force generated at the contact point or area between that pad and the ground, and R may be a position vector from the axis of rotation (In this case, the center of the apparatus) to the point or area of contact between a pad and the ground.

First Mode, Fixed Angular Velocity.

In a first mode of operation, as the angle θ of a pad changes, the position of the contact point or area between that pad and the ground changes as well. Therefore, a pad angle θ changes, the position vector R from the axis of rotation to the contact point between the pad and the ground may change as well. In an embodiment, method 500 may determine the level of τₜₒₜₐₗ necessary to achieve the desired amount of rotational motion, and the torque needed at one or more pads to generate the needed τₜₒₜₐₗ. Method 500 may then calculate the angle θ necessary at those pads to generate the desired Fₜₒₜₐₗ and τₜₒₜₐₗ. Subsequently, at 505, method 500 may adjust the angle θ of those pads accordingly.

Second Mode, Fixed Angles.

In a second mode of operation, because the angle θ of each pad may be fixed, it follows that the position vector (R) between the axis of rotation and the contact point of each pad may not change (since both contact points and axis of rotation are now fixed). However, as discussed herein, changes in the ω of a pad may relate to changes in the force (and thus, the torque) generated at that pad. Method 500 may determine the level of τₜₒₜₐₗ needed to achieve the desired amount of rotational movement and the torque needed at one or more pads 103a-c to achieve the desired τₜₒₜₐₗ. In an embodiment, method 500 may determine the ω needed at those pads to generate both the desired Fₜₒₜₐₗ and τₜₒₜₐₗ. Subsequently, at box 505, method 500 may then adjust the ω of those pads accordingly. Thus, in various embodiments, method 500 may control both Fₜₒₜₐₗ and τₜₒₜₐₗ simultaneously by varying the angle θ or the ω of one or more pads.

At 506, method 500 may maintain the stability of translational and/or rotational movement, in one embodiment taking into account orientation and/or angular velocity information. For example, as noted previously, information about sudden changes in orientation, or changes in angular velocity of one or more pads may signify changes in traction at those pads, or changes in the surface over which those pads are operating. Such changes could result in an unwanted change in direction and/or rotation of the robot.

Upon determining the force vectors necessary at one or more pads to achieve an Fₜₒₜₐₗ corresponding to a desired direction of travel and controlling one or more motors or servos accordingly, method 500 may determine the appropriate ratio between the force vectors at the respective pads. Method 500 may then monitor changes in movement (rotational and/or translational) and/or orientation to ensure that the ratio of the force vectors produced fits within the determined ratio. Method 500 may utilize a gyroscope or other sensor to obtain information about these changes in movement and/or orientation.

At 507, in an embodiment, method 500 may detect ratio shifts that are above a threshold. Such shifts may, for example, be indicative of a loss of traction in one or more pads, or a change in surface over which one or more pads are operating which may cause an unwanted change in the angle of orientation and/or speed of those pads. Subsequently, the unwanted change in angle of orientation or speed of one or more pads may generate an unwanted change in the force vector generated at that pad, resulting in a shift in the ratio among the force vectors and an unwanted change of direction of the cleaning apparatus. If no change is detected, method 500 may continue to monitor the ratio of the force vectors.

At 508, upon detecting a change in force vector ratio, method 500 may calculate the force vector necessary at one or more pads to restore the ratio between force vectors and stabilize the robot.

First Mode, Fixed Angular Velocity.

In a first mode of operation, method 500 may calculate the angle θ needed at those pads to generate the respective force vectors and instruct the respective servos of those pads to shift their angle θ accordingly.

Second Mode, Fixed Angles.

In a second mode of operation, method 500 may calculate the ω needed at those pads to generate the respective force vectors and instruct the respective motors of those pads to shift their angle θ accordingly.

In an embodiment, the method 500 may dispense cleaning fluid, as discussed earlier, to help provide a more thorough cleaning function. Method 500 may dispense the cleaning fluid at predetermined time intervals, upon detecting that a change in direction is needed, or alternatively may dispense the cleaning fluid based upon any other criterion or criteria relevant to the operation of the apparatus.

In response to detecting an area or surface that is difficult to traverse in the normal mode of operation, method 500 may instruct one or more servos to orient their respective pads in a fully articulated manner, such that the pads operate similarly to wheels, as mentioned earlier.

In the embodiment of FIG. 5, rotational motion is shown as being determined after translation is determined. However, rotational motion may be determined on its own, independently of any translation.

### Electronics Diagram

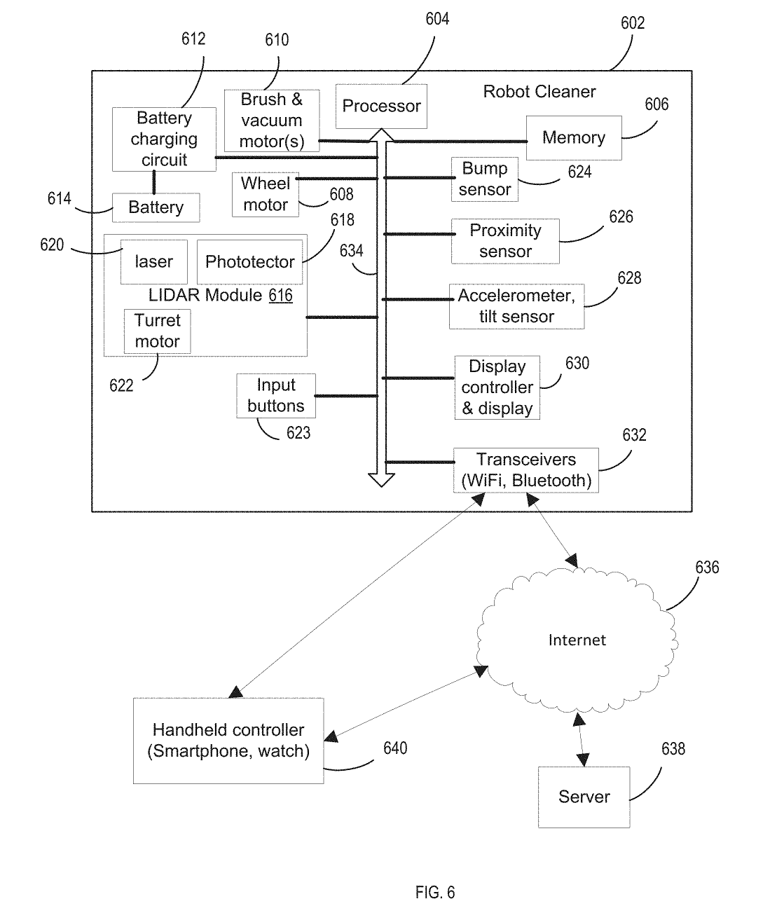

FIG. 6 is a high level diagram of a the electronic system for a robot according to an embodiment. A robot 602 includes a processor 604 that operates a program downloaded to memory 606. The processor communicates with other components using a bus 634 or other electrical connections. In a cleaning or other treatment mode, wheel motors 608 control the wheels independently to move and steer the robot. Brush and vacuum motors 610 clean the floor, and can be operated in different modes, such as a higher power intensive cleaning mode or a normal power mode.

LIDAR module 616 includes a laser 620 and a detector 616. Alternately, an image sensor can be used with a VSLAM operation. A turret motor 622 moves the laser and detector or other localization sensor to detect objects up to 360 degrees around the robot. There are multiple rotations per second, such as about 5 rotations per second. Various sensors provide inputs to processor 604, such as a bump sensor 624 indicating contact with an object, proximity sensor 626 indicating closeness to an object, and accelerometer and tilt sensors 628, which indicate a drop-off (e.g., stairs) or a tilting of the robot (e.g., upon climbing over an obstacle). Examples of the usage of such sensors for navigation and other controls of the robot are set forth in U.S. Pat. No. 8,855,914, “Method and apparatus for traversing corners of a floored area with a robotic surface treatment apparatus,” the disclosure of which is incorporated herein by reference. Other sensors may be included in other embodiments, such as a dirt sensor for detecting the amount of dirt being vacuumed, a motor current sensor for detecting when the motor is overloaded, such as due to being entangled in something, a floor sensor for detecting the type of floor, and an image sensor (camera) for providing images of the environment and objects.

A battery 614 provides power to the rest of the electronics though power connections (not shown). A battery charging circuit 612 provides charging current to battery 614 when the robot is docked with charging station 206 of FIG. 2. Input buttons 623 allow control of robot cleaner 602 directly, in conjunction with a display 630. Alternately, robot 602 may be controlled remotely, and send data to remote locations, through transceivers 632.

Through the Internet 636, and/or other network(s), the robot can be controlled, and can send information back to a remote user. A remote server 638 can provide commands, and can process data uploaded from the robot. A handheld smartphone or watch 640 can be operated by a user to send commands either directly to robot 602 (through Bluetooth, direct RF, a WiFi LAN, etc.) or can send commands through a connection to the internet 636. The commands could be sent to server 638 for further processing, then forwarded in modified form to robot 602 over the internet 636.

### Computer Systems for Media Platform and Client System

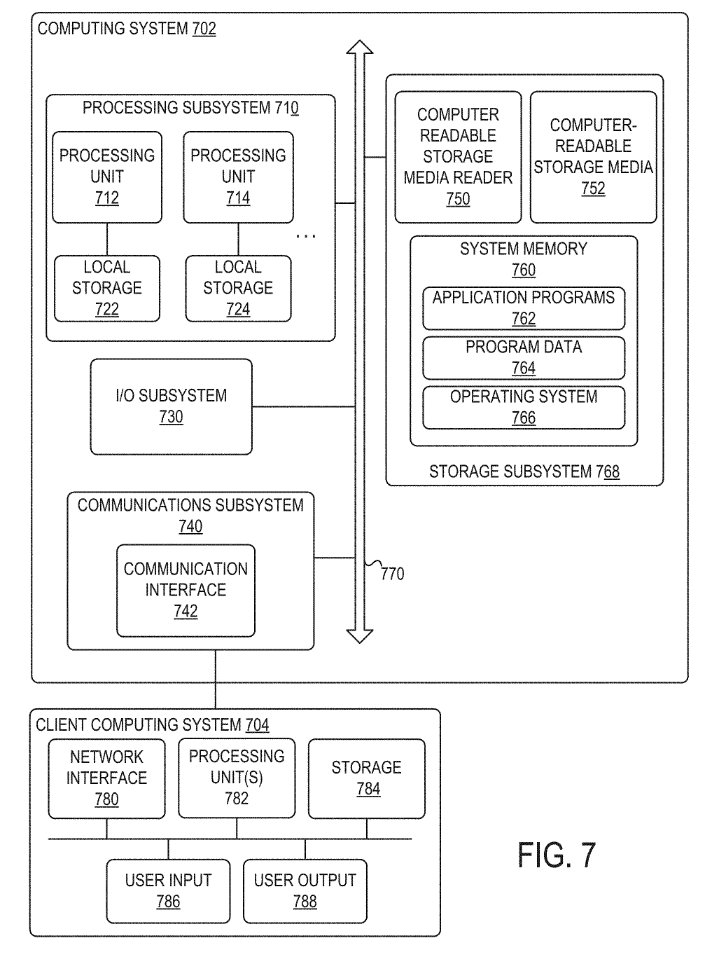

Various operations described herein may be implemented on computer systems. FIG. 7 shows a simplified block diagram of a representative computing system 702 and client computing system 704 usable to implement certain embodiments of the present invention. In various embodiments, computing system 702 or similar systems may implement the robot processor system, remote server, or any other computing system described herein or portions thereof. Client computing system 704 or similar systems may implement user devices such as a smartphone or watch with a robot cleaner application.

Computing system 702 may be one of various types, including processor and memory, a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 702 may include processing subsystem 710. Processing subsystem 710 may communicate with a number of peripheral systems via bus subsystem 770. These peripheral systems may include I/O subsystem 730, storage subsystem 768, and communications subsystem 740.

Bus subsystem 770 provides a mechanism for letting the various components and subsystems of server computing system 704 communicate with each other as intended. Although bus subsystem 770 is shown schematically as a single bus, alternative embodiments of the bus subsystem may utilize multiple buses. Bus subsystem 770 may form a local area network that supports communication in processing subsystem 710 and other components of server computing system 702. Bus subsystem 770 may be implemented using various technologies including server racks, hubs, routers, etc. Bus subsystem 770 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 730 may include devices and mechanisms for inputting information to computing system 702 and/or for outputting information from or via computing system 702. In general, use of the term “input device” is intended to include all possible types of devices and mechanisms for inputting information to computing system 702. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 702 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 710 controls the operation of computing system 702 and may comprise one or more processing units 712, 714, etc. A processing unit may include one or more processors, including single core processor or multicore processors, one or more cores of processors, or combinations thereof. In some embodiments, processing subsystem 710 may include one or more special purpose co-processors such as graphics processors, digital signal processors (DSPs), or the like. In some embodiments, some or all of the processing units of processing subsystem 710 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 722, 724. Any type of processors in any combination may be included in processing unit(s) 712, 714.

In some embodiments, processing subsystem 710 may be implemented in a modular design that incorporates any number of modules (e.g., blades in a blade server implementation). Each module may include processing unit(s) and local storage. For example, processing subsystem 710 may include processing unit 712 and corresponding local storage 722, and processing unit 714 and corresponding local storage 724.

Local storage 722, 724 may include volatile storage media (e.g., conventional DRAM, SRAM, SDRAM, or the like) and/or non-volatile storage media (e.g., magnetic or optical disk, flash memory, or the like). Storage media incorporated in local storage 722, 724 may be fixed, removable or upgradeable as desired. Local storage 722, 724 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 712, 714 need at runtime. The ROM may store static data and instructions that are needed by processing unit(s) 712, 714. The permanent storage device may be a non-volatile read-and-write memory device that may store instructions and data even when a module including one or more processing units 712, 714 and local storage 722, 724 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 722, 724 may store one or more software programs to be executed by processing unit(s) 712, 714, such as an operating system and/or programs implementing various server functions such as functions of UPP system 102, or any other server(s) associated with UPP system 102. “Software” refers generally to sequences of instructions that, when executed by processing unit(s) 712, 714 cause computing system 702 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 712, 714. In some embodiments the instructions may be stored by storage subsystem 768 (e.g., computer readable storage media). In various embodiments, the processing units may execute a variety of programs or code instructions and may maintain multiple concurrently executing programs or processes. At any given time, some or all of the program code to be executed may be resident in local storage 722, 724 and/or in storage subsystem including potentially on one or more storage devices. Software may be implemented as a single program or a collection of separate programs or program modules that interact as desired. From local storage 722, 724 (or non-local storage described below), processing unit(s) 712, 714 may retrieve program instructions to execute and data to process in order to execute various operations described above.

Storage subsystem 768 provides a repository or data store for storing information that is used by computing system 702. Storage subsystem 768 provides a tangible non-transitory computer-readable storage medium for storing the basic programming and data constructs that provide the functionality of some embodiments. Software (programs, code modules, instructions) that when executed by processing subsystem 710 provide the functionality described above may be stored in storage subsystem 768. The software may be executed by one or more processing units of processing subsystem 710. Storage subsystem 768 may also provide a repository for storing data used in accordance with the present invention.

Storage subsystem 768 may include one or more non-transitory memory devices, including volatile and non-volatile memory devices. As shown in FIG. 7, storage subsystem 768 includes a system memory 760 and a computer-readable storage media 752. System memory 760 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 702, such as during start-up, may typically be stored in the ROM. The RAM typically contains data and/or program modules that are presently being operated and executed by processing subsystem 710. In some implementations, system memory 760 may include multiple different types of memory, such as static random access memory (SRAM) or dynamic random access memory (DRAM). Storage subsystem 768 may be based on magnetic, optical, semiconductor, or other data storage media. Direct attached storage, storage area networks, network-attached storage, and the like may be used. Any data stores or other collections of data described herein as being produced, consumed, or maintained by a service or server may be stored in storage subsystem 768.

By way of example, and not limitation, as depicted in FIG. 7, system memory 760 may store application programs 762, which may include client applications, Web browsers, mid-tier applications, relational database management systems (RDBMS), etc., program data 764, and one or more operating systems 766. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 752 may store programming and data constructs that provide the functionality of some embodiments. Software (programs, code modules, instructions) that when executed by processing subsystem 710 a processor provide the functionality described above may be stored in storage subsystem 768. By way of example, computer-readable storage media 752 may include non-volatile memory such as a hard disk drive, a magnetic disk drive, an optical disk drive such as a CD ROM, DVD, a Blu-Ray® disk, or other optical media. Computer-readable storage media 752 may include, but is not limited to, Zip® drives, flash memory cards, universal serial bus (USB) flash drives, secure digital (SD) cards, DVD disks, digital video tape, and the like. Computer-readable storage media 752 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 752 may provide storage of computer-readable instructions, data structures, program modules, and other data for computing system 702.

In certain embodiments, storage subsystem 768 may also include a computer-readable storage media reader 750 that may further be connected to computer-readable storage media 752. Together and, optionally, in combination with system memory 760, computer-readable storage media 752 may comprehensively represent remote, local, fixed, and/or removable storage devices plus storage media for storing computer-readable information.

In certain embodiments, computing system 702 may provide support for executing one or more virtual machines. Computing system 702 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 702. Accordingly, multiple operating systems may potentially be run concurrently by computing system 702. Each virtual machine generally runs independently of the other virtual machines.

Communication subsystem 740 provides an interface to other computer systems and networks. Communication subsystem 740 serves as an interface for receiving data from and transmitting data to other systems from computing system 702. For example, communication subsystem 740 may enable computing system 702 to establish a communication channel to one or more client computing devices via the Internet for receiving and sending information from and to the client computing devices.

Communication subsystem 740 may support both wired and/or wireless communication protocols. For example, in certain embodiments, communication subsystem 740 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 740 may provide wired network connectivity (e.g., Ethernet) in addition to or instead of a wireless interface.

Communication subsystem 740 may receive and transmit data in various forms. For example, in some embodiments, communication subsystem 740 may receive input communication in the form of structured and/or unstructured data feeds, event streams, event updates, and the like. For example, communication subsystem 740 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 740 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 740 may also be configured to output the structured and/or unstructured data feeds, event streams, event updates, and the like to one or more databases that may be in communication with one or more streaming data source computers coupled to computing system 702.

Communication subsystem 740 may provide a communication interface 742, e.g., a WAN interface, which may provide data communication capability between the local area network (bus subsystem 770) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 702 may operate in response to requests received via communication interface 742. Further, in some embodiments, communication interface 742 may connect computing systems 702 to each other, providing scalable systems capable of managing high volumes of activity. Conventional or other techniques for managing server systems and server farms (collections of server systems that cooperate) may be used, including dynamic resource allocation and reallocation.

Computing system 702 may interact with various user-owned or user-operated devices via a wide-area network such as the Internet. An example of a user-operated device is shown in FIG. 7 as client computing system 702. Client computing system 704 may be implemented, for example, as a consumer device such as a smart phone, other mobile phone, tablet computer, wearable computing device (e.g., smart watch, eyeglasses), desktop computer, laptop computer, and so on.

For example, client computing system 704 may communicate with computing system 702 via communication interface 742. Client computing system 704 may include conventional computer components such as processing unit(s) 782, storage device 784, network interface 780, user input device 786, and user output device 788. Client computing system 704 may be a computing device implemented in a variety of form factors, such as a desktop computer, laptop computer, tablet computer, smart phone, other mobile computing device, wearable computing device, or the like.

Processing unit(s) 782 and storage device 784 may be similar to processing unit(s) 712, 714 and local storage 722, 724 described above. Suitable devices may be selected based on the demands to be placed on client computing system 704; for example, client computing system 704 may be implemented as a “thin” client with limited processing capability or as a high-powered computing device. Client computing system 704 may be provisioned with program code executable by processing unit(s) 782 to enable various interactions with computing system 702 of a message management service such as accessing messages, performing actions on messages, and other interactions described above. Some client computing systems 704 may also interact with a messaging service independently of the message management service.

Network interface 780 may provide a connection to a wide area network (e.g., the Internet) to which communication interface 740 of computing system 702 is also connected. In various embodiments, network interface 780 may include a wired interface (e.g., Ethernet) and/or a wireless interface implementing various RF data communication standards such as Wi-Fi, Bluetooth, or cellular data network standards (e.g., 3G, 4G, LTE, etc.).

User input device 786 may include any device (or devices) via which a user may provide signals to client computing system 704; client computing system 704 may interpret the signals as indicative of particular user requests or information. In various embodiments, user input device 786 may include any or all of a keyboard, touch pad, touch screen, mouse or other pointing device, scroll wheel, click wheel, dial, button, switch, keypad, microphone, and so on.

User output device 788 may include any device via which client computing system 704 may provide information to a user. For example, user output device 788 may include a display to display images generated by or delivered to client computing system 704. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that function as both input and output device. In some embodiments, other user output devices 788 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 712, 714 and 782 may provide various functionality for computing system 702 and client computing system 704, including any of the functionality described herein as being performed by a server or client, or other functionality associated with message management services.

It will be appreciated that computing system 702 and client computing system 704 are illustrative and that variations and modifications are possible. Computer systems used in connection with embodiments of the present invention may have other capabilities not specifically described here. Further, while computing system 702 and client computing system 704 are described with reference to particular blocks, it is to be understood that these blocks are defined for convenience of description and are not intended to imply a particular physical arrangement of component parts. For instance, different blocks may be but need not be located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present invention may be realized in a variety of apparatus including electronic devices implemented using any combination of circuitry and software.

### Mapping and Controls

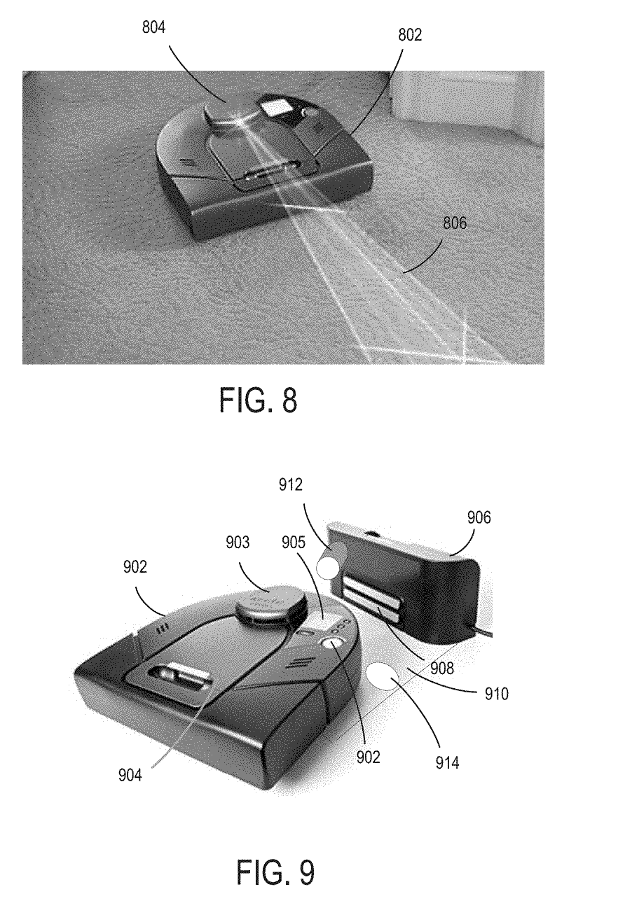

FIG. 8 is a diagram of a robot with a LIDAR turret according to an embodiment. A robot 802 has a LIDAR (Light Detection and Ranging) turret 804 which emits a rotating laser beam 806. Detected reflections of the laser beam off objects are used to calculate both the distance to objects and the location of the robot. One embodiment of the distance calculation is set forth in U.S. Pat. No. 8,996,172, “Distance sensor system and method,” the disclosure of which is incorporated herein by reference. The collected data is also used to create a map, using a SLAM (Simultaneous Location and Mapping) algorithm. One embodiment of a SLAM algorithm is described in U.S. Pat. No. 8,903,589, “Method and apparatus for simultaneous localization and mapping of mobile robot environment,” the disclosure of which is incorporated herein by reference.

FIG. 9 is a diagram of a robot and charging station according to an embodiment. Robot 902 with turret 903 is shown. Also shown is a cover 904 which can be opened to access the interior of the robot. Buttons 902 allow basic operations of the robot cleaner, such as starting a cleaning operation. A display 905 provides information to the user. Robot 902 can dock with a charging station 906, and receive electricity through charging contacts 908. A cleaning tray 910 for washing the pads can be provided in front of the charging station, with a water/soap inlet 912 and a drain 914.

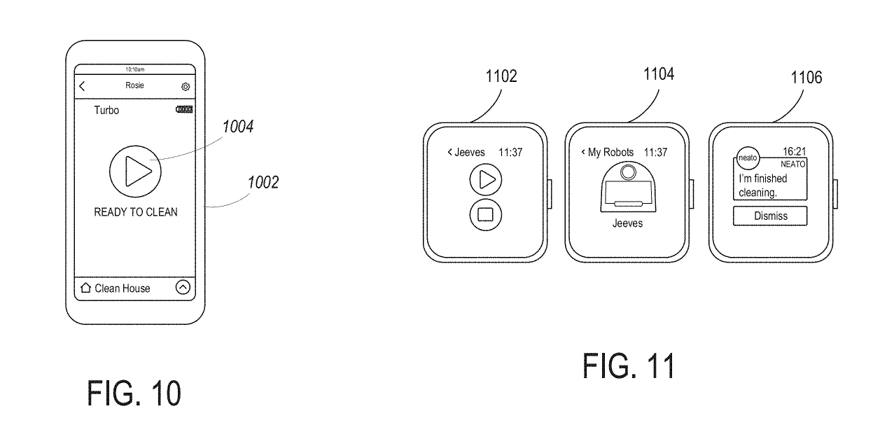

FIG. 10 is a diagram of a smartphone control application display for a robot according to an embodiment. A smartphone 1002 has an application that is downloaded to control the robot. An easy to use interface has a start button 1004 to initiate cleaning.

FIG. 11 is a diagram of a smart watch control application display for a robot according to an embodiment. Example displays are shown. A display 1102 provides and easy to use start button. A display 1104 provides the ability to control multiple robots. A display 1106 provides feedback to the user, such as a message that the robot has finished.

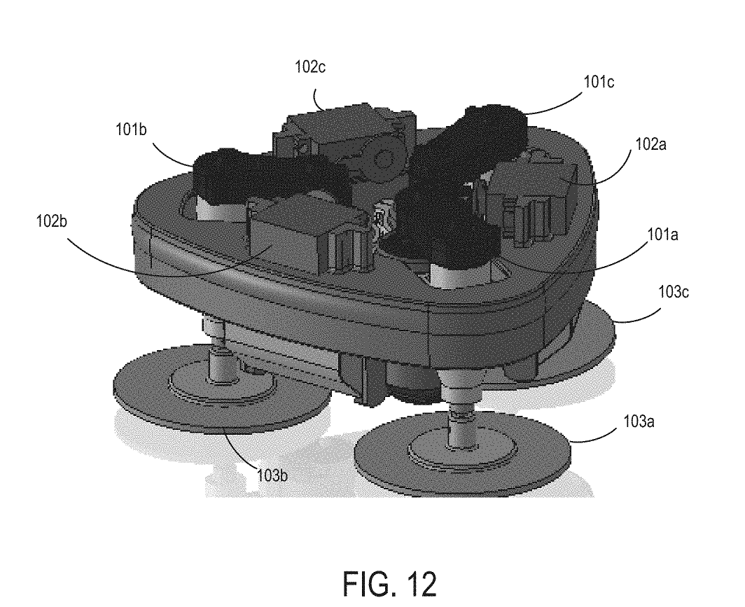

FIG. 12 illustrates a perspective view of the robot of FIG. 2 according to an embodiment of the present disclosure. FIG. 12 provides an example configuration of motors 101a-c, servos 102a-c, and pads 103a-c.

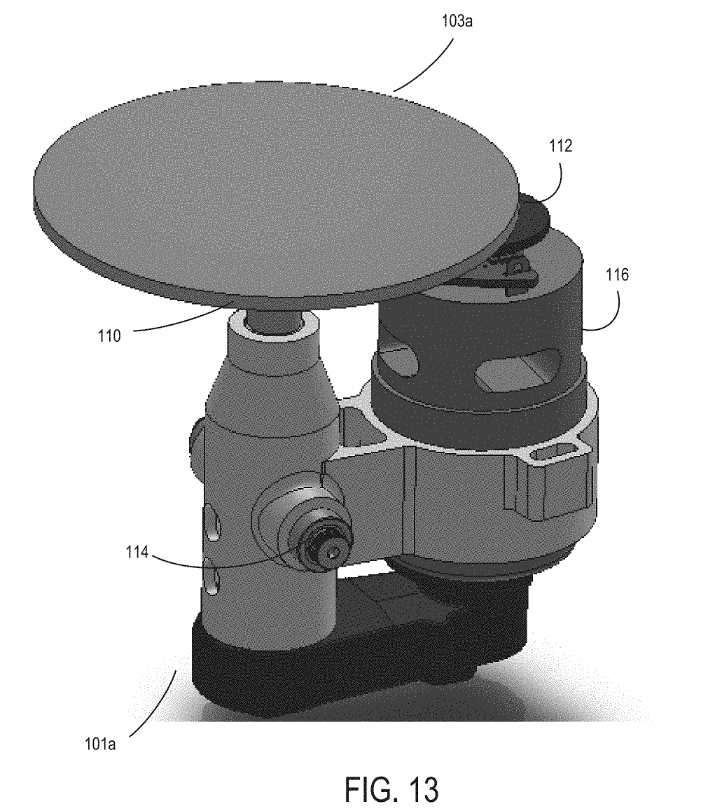

FIG. 13 illustrates a perspective view of one servo motor and pad combination of the robot of FIG. 12 according to an embodiment of the present disclosure. The view of FIG. 13 is from the bottom, showing the bottom of pad 103a. An axle 110 driven by motor 101a causes pad 103a to rotate. Tilting of pad 103a is accomplished using a disk 112, which is mounted on an arm 116 which is biased up and down by pivoting on an axle 114. A servo, not shown in this view, biases arm 116 to tilt pad 103a.

While the invention has been described with respect to specific embodiments, one skilled in the art will recognize that numerous modifications are possible. Embodiments of the invention may be realized using a variety of computer systems and communication technologies including but not limited to specific examples described herein.

Embodiments of the present invention may be realized using any combination of dedicated components and/or programmable processors and/or other programmable devices. The various processes described herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

Although the invention has been described in language specific to structural features and/or methodological steps, it is to be understood that the invention is not to be limited to the specific features or steps disclosed. Rather, the specific features and steps are disclosed as preferred forms of implementing the invention, which is to be defined by the claims.

What is claimed is:

1. A mobile robotic apparatus comprising:
three pads;
three motors, each configured to rotate a respective pad at a rotational velocity;
wherein, for each of the three pads, the rotational velocity and the orientation angle define a force vector between the pad and the surface; and
a microprocessor, responsive to commands for at least one of a rotation and a translation of the apparatus, the microprocessor configured to:
responsive to commands for the rotation of the apparatus:
calculate a rotational force vector required at one or more of the pads in order to achieve the rotation;
determine a necessary rotational velocity for one or more of the motors in order to generate the rotational force vector to achieve the rotation,
calculate a translational force vector required at one or more of the pads in order to achieve the translation; and
determine a necessary rotational velocity for one or more of the motors in order to generate the translational force vector.

2. The apparatus of claim 1, wherein:
responsive to determining a necessary rotational velocity for one or more motors, the microprocessor is further configured to instruct each of the one or more motors to change the rotational velocity of a respective pad to the determined rotational velocity.

3. The apparatus of claim 1, further comprising a remote control to provide the commands for at least one of a rotation and translation of the apparatus.

4. The apparatus of claim 2, further comprising a rotational sensor configured to send a signal to the microprocessor indicating a change in the force vector generated at one or more pads;
wherein the microprocessor is configured to respond to the rotational sensor signal as necessary, and, if the signal indicates a change in the force vectors generated at each pad that is above a threshold, calculate the force vector required at one or more pads to adjust the force vectors generated at each pad to maintain the force vectors within the threshold.

5. The apparatus of claim 1, wherein the pads are cleaning pads.

6. The apparatus of claim 5, further comprising a fluid dispenser to dispense cleaning fluid to one or more of the cleaning pads.

7. The apparatus of claim 5, wherein the cleaning pads comprise pads selected from the group consisting of polishing pads, sanding pads, dry mopping pads, wet mopping pads, and dusting pads.

8. The apparatus of claim 5, wherein each cleaning pad includes a surface selected from the group consisting of a lining, ring, omni wheel, and Ezekiel wheel.

9. The apparatus of claim 6, wherein the cleaning fluid comprises fluid selected from the group consisting of floor wax, floor polish, solvent, detergent, soap, and soap solution.

10. A mobile robotic apparatus comprising:
three pads;
three motors, each configured to rotate a respective pad at a rotational velocity;
three servos, each configured to tilt a respective pad about an axis at an orientation angle relative to a surface;
wherein, for each of the three pads, the rotational velocity and the orientation angle define a force vector between the pad and the surface; and
a microprocessor, responsive to commands for at least one of a rotation and a translation of the apparatus, the microprocessor configured to:
responsive to commands for the rotation of the apparatus:
calculate a rotational force vector required at one or more of the pads in order to achieve the rotation;
determine a necessary orientation angle for one or more of the servos in order to generate the rotational force vector to achieve the rotation;
responsive to commands for translation motion of the apparatus:
calculate a translational force vector required at one or more of the pads in order to achieve the translation;
determine one a necessary orientation angle for one or more of the servos in order to generate the translational force vector to achieve the translation.

11. The apparatus of claim 10, wherein responsive to determining a necessary orientation angle for one or more servos, the microprocessor is further configured to instruct each of the one or more servos to change the orientation angle of a respective pad to the determined orientation angle.

12. The apparatus of claim 10, wherein each pad is configured to tilt about a single axis.

13. A method of controlling an apparatus having three pads for providing rotational and translational movement of the apparatus, the method comprising:
generating, using a microprocessor, commands to control at least one of a rotation of the apparatus, and a translational movement of the apparatus in a desired direction at a desired speed;
responsive to commands for the rotation of the apparatus:
calculating, using the microprocessor, a rotational force vector required at each of three pads in order to achieve the rotation;
determining, using the microprocessor, one of:
(i) a necessary rotational velocity for one or more motors in order to generate the rotational force vector to achieve the rotation,
(ii) a necessary orientation angle for one or more servos in order to generate the rotational force vector to achieve the rotation;
responsive to commands for translational motion of the apparatus:
calculating, using the microprocessor, a translational force vector required at one or more of the pads in order to achieve the translational motion;
determining, using the microprocessor, one of:
(i) a necessary rotational velocity for one or more of the motors in order to generate the translational force vector,
(ii) a necessary orientation angle for one or more of the servos in order to generate the translational force vector to achieve the translational motion.

14. The method of claim 13, further comprising:
responsive to determining a necessary rotational velocity for each of the motors, instructing each of the motors, as necessary, to change the rotational velocity of their respective pads to the determined rotational velocity.

15. The method of claim 13, further comprising:
responsive to determining a necessary orientation angle for each of the servos, instructing each of the servos, as necessary, to change the orientation angle of their respective pad to the determined orientation angle.

16. The method of claim 13, wherein the commands for at least one of a rotation and translation of the apparatus are generated by a remote control.

17. The method of claim 14, further comprising:
sending, using a rotation sensor, a signal indicating a change in the force vector generated at one or more pads;
responding to the rotation sensor signal as necessary, and, if the signal indicates a shift in the force vectors generated at each pad that is above a threshold, calculate the force vector required at one or more pads to adjust the force vectors generated at each pad to maintain the force vectors within the threshold.

18. The method of claim 13, wherein the pads are cleaning pads.

19. The method of claim 18, wherein the cleaning pads comprise pads selected from the group consisting of polishing pads, sanding pads, dry mopping pads, wet mopping pads, and dusting pads.

20. The method of claim 18, wherein each cleaning pad includes a surface selected from the group consisting of a lining, ring, omni wheel, and Ezekiel wheel.
